(19) United States
(12) Patent Application Publication
(10) Pub. No.: US 2025/0196571 A1
(43) Pub. Date: Jun. 19, 2025

(54) AIR CONDITIONER FOR VEHICLE

(71) Applicant: Hanon Systems, Daejeon (KR)

(72) Inventors: Yong Ho Kim, Daejeon (KR); Jong Su Kim, Daejeon (KR); Jin Uk Kim, Daejeon (KR); Sang Chul Byon, Daejeon (KR); Woo Hyun Jung, Daejeon (KR); Sung Been Cheon, Daejeon (KR)

(21) Appl. No.: 18/964,945

(22) Filed: Dec. 2, 2024

(30) Foreign Application Priority Data
Dec. 14, 2023 (KR) 10-2023-0182358

(51) Int. Cl. B60H 1/00

(52) U.S. Cl. CPC B60H 1/00664; B60H 1/00064; B60H 1/00285; B60H 1/00321

(57) ABSTRACT

Disclosed is an air conditioner for a vehicle that enables precise temperature control when mixing cold air and warm air and reduces the resistance in a warm air passage, thus increasing the air volume. The air conditioner for a vehicle includes an air conditioning case having an air passage formed therein, and a cooling heat exchanger and a heating heat exchanger sequentially provided in the air passage in an airflow direction, wherein the air passage includes a cold air passage through which air passing through the cooling heat exchanger bypasses the heating heat exchanger and a warm air passage through which air passing through the cooling heat exchanger passes through the heating heat exchanger, a first temperature door for controlling the opening degree of the cold air passage and a second temperature door for controlling the opening degree of the warm air passage are provided, and when the second temperature door opens the warm air passage, the second temperature door guides the warm air passing through the heating heat exchanger to the cold air passage.

### BACKGROUND OF THE INVENTION

### Field of the Invention

The present invention relates to an air conditioner for a vehicle, and more particularly, to an air conditioner for a vehicle which is installed at the rear seat area of the vehicle to independently perform air conditioning for the rear seat, regardless of a front air conditioner for the vehicle.

### Background Art

In general, an air conditioner for a vehicle is an apparatus for cooling or heating the interior of the vehicle by cooling or heating through the process of introducing outdoor air into the interior of the vehicle or circulating indoor air of the vehicle. Such an air conditioner for a vehicle includes an evaporator for a cooling action and a heater core for a heating action inside an air-conditioning case, and selectively blows the air cooled by the evaporator or heated by the heater core toward each part of the interior of the vehicle using a door for switching the blowing mode.

The air conditioner for a vehicle is configured to discharge cooling air or heating air from a vent duct installed on an instrument panel of the interior front of the vehicle, so in vehicles with larger interior spaces, such as luxury cars, vans, or four-wheel-drive vehicles, the cooling or heating effect may not be sufficient to reach the rear seats. To overcome the problem, vehicles with larger interior spaces have additional rear air conditioner installed between the side out panel and the luggage trim to assist the cooling and heating functions for the rear seat area.

FIG. 1 is a cross-sectional view of a conventional rear air conditioner for a vehicle. Referring to FIG. 1, the conventional rear air conditioner for a vehicle includes an air blower 50, a case 10, an evaporator 20, and a heater core 30. The case 10 has an internal air passage, and an air blower 50 is installed on an air inflow port of the case 10. The air discharge port of the case 10 has a vent discharge port 12 for directing conditioned air upward of the vehicle and a floor discharge port 11 for directing conditioned air downward of the vehicle.

Within the air passage of the case 10, an evaporator 20 which is a cooling heat exchanger, and a heater core 30 which is a heating heat exchanger are sequentially arranged in an airflow direction. A temperature door 40 is provided between the evaporator 20 and the heater core 30 to control the volume of air passing through the heater core 30 and the volume of air bypassing the heater core 30, thereby adjusting the temperature of the conditioned air flowing out of the air discharge ports.

In a heating mode, the temperature door 40 opens a warm air passage passing through the heater core 30 and closes the cold air passage bypassing the heater core 30. The air blown from the air blower 50 passes through the evaporator 20, and then is heated by exchanging heat with coolant circulating through the heater core 30 while passing through the heater core 30. Thereafter, the heated air is discharged into the interior of the vehicle through the vent discharge port 12 and floor discharge port 11.

In a cooling mode, the temperature door 40 closes the warm air passage passing through the heater core 30 and opens the cold air passage bypassing the heater core 30. The air blown from the air blower 50 passes through the evaporator 20, is cooled by exchanging heat with refrigerant circulating through the evaporator 20, and then, is discharged into the interior of the vehicle through the vent discharge port 12 and floor discharge port 11.

Referring to FIG. 2, in a mixing mode, where cold air and warm air are mixed, the temperature door 40 opens both the warm air passage passing through the heater core 30 and the cold air passage bypassing the heater core 30. Some of the air blown from the air blower 50 passes through the evaporator 20 and is cooled by exchanging heat with the refrigerant circulating through the evaporator 20, while other air passes through the heater core 30 and is heated by exchanging heat with the coolant circulating through the heater core 30. Thereafter, the cooled air and the heated air are mixed in a mixing zone, and then, discharged into the interior of the vehicle through the vent discharge port 12 and the floor discharge port 11.

The conventional rear air conditioner has a single temperature door 40, so it difficult to achieve precise temperature control when mixing cold air and warm air. Additionally, since the heater core 30 is placed inside the air conditioning case 10, the narrow warm air passage creates increased resistance, thus reducing the air volume.

### SUMMARY OF THE INVENTION

Accordingly, the present invention has been made to solve the above-mentioned problems occurring in the prior arts, and it is an objective of the present invention to provide an air conditioner for a vehicle that enables precise temperature control when mixing cold air and warm air and reduces the resistance in a warm air passage, thus increasing the air volume.

To accomplish the above object, according to the present invention, there is provided an air conditioner for a vehicle, which includes an air conditioning case having an air passage formed therein, and a cooling heat exchanger and a heating heat exchanger sequentially provided in the air passage in an airflow direction, wherein the air passage includes a cold air passage through which air passing through the cooling heat exchanger bypasses the heating heat exchanger, and a warm air passage through which air passing through the cooling heat exchanger passes through the heating heat exchanger, a first temperature door for controlling the opening degree of the cold air passage and a second temperature door for controlling the opening degree of the warm air passage are provided, and when the second temperature door opens the warm air passage, the second temperature door guides the warm air passing through the heating heat exchanger to the cold air passage.

A plurality of air discharge ports are formed in the air conditioning case, and the plurality of the air discharge ports are formed at an upper portion of the air conditioning case.

The air conditioning case is provided at a rear seat of the vehicle and performs air conditioning for the rear seat of the vehicle.

The second temperature door is arranged downstream of the heating heat exchanger in an airflow direction.

The second temperature door is a flat type having a flat that rotates around a rotary shaft, and the opening direction of the second temperature door is toward the cold air passage downstream of the first temperature door in the airflow direction.

The second temperature door has a structure that flats extend on both sides around the rotary shaft, and when the second temperature door is fully opened, the flats are formed parallel toward the cold air passage downstream of the first temperature door in the airflow direction.

The second temperature door is offset toward the cold air passage relative to the center in the longitudinal direction of the heating heat exchanger.

The air discharge ports include a face vent for discharging air toward a passenger's face and a floor vent for discharging air toward the passenger's feet, a mode door for adjusting the opening degree between the face vent and the floor vent is provided, and an upper closing surface of the second temperature door is located within the rotation radius of the mode door.

The cooling heat exchanger and the heating heat exchanger are arranged to be laid horizontally, and the heating heat exchanger is arranged adjacent to the air discharge port through which warm air is discharged.

The heating heat exchanger is arranged so that in a heating mode, warm air flows directly into the floor vent.

The warm air passage through which air passing through the heating heat exchanger flows is arranged adjacent to the floor vent, and the cold air passage through which air passing through the cooling heat exchanger and bypassing the heating heat exchanger flows is arranged adjacent to the face vent.

When the second temperature door opens the warm air passage, the second temperature door faces an upper portion of the first temperature door in the vertical direction.

The first temperature door and the second temperature door all have flats that rotate around the rotary shaft, and when both the first temperature door and the second temperature door are opened simultaneously, an extension line of a flat end of the first temperature door and an extension line of a flat end of the second temperature door meet in an upstream space of the mode door in the airflow direction.

When the first temperature door is opened, cold air moves vertically toward the air discharge port located above the first temperature door, and when the second temperature door is opened, warm air moves to meet the cold air moving upward, forming a mixing zone below the air discharge port.

The rotary shaft of the second temperature door is arranged closer to the rotary shaft of the first temperature door than to the center in the longitudinal direction of the heating heat exchanger.

The mode door is formed in a dome-shape which rotates around the rotary shaft, and when both the first temperature door and the second temperature door are opened, the upper closing surface of the second temperature door is located within the dome of the mode door in a front-rear direction of the vehicle.

The mode door is formed in a dome-shape which rotates around the rotary shaft, and the rotary shaft of the mode door is located above the rotary shaft of the second temperature door in the vertical direction.

The air conditioner for a vehicle according to the present invention optimizes the position of the heater core and the opening direction and position of the second temperature door to reduce ventilation resistance and increase air volume, thereby reducing energy consumption of the blower motor of the air blower, improving air conditioning efficiency, and improving the comfort of the vehicle's interior by enhancing the mixing capability of cold air and warm air.

### BRIEF DESCRIPTION OF THE DRAWINGS

FIG. 1 is a side cross-sectional view of a conventional rear air conditioner for a vehicle.

FIG. 2 illustrates a mixing mode of cold air and warm air in the conventional rear air conditioner for a vehicle.

FIG. 3 is a side cross-sectional view of an air conditioner for a vehicle according to an embodiment of the present invention.

FIG. 4 is a partially enlarged side cross-sectional view illustrating the air conditioner for a vehicle according to an embodiment of the present invention.

FIG. 5 illustrates a vent mode of the air conditioner for a vehicle according to an embodiment of the present invention.

FIG. 6 illustrates a floor mode of the air conditioner for a vehicle according to an embodiment of the present invention. FIG. 7 illustrates a bi-level mode of the air conditioner for a vehicle according to an embodiment of the present invention.

FIG. 8 shows experimental results demonstrating the reduction of ventilation resistance in the air conditioner for a vehicle according to an embodiment of the present invention.

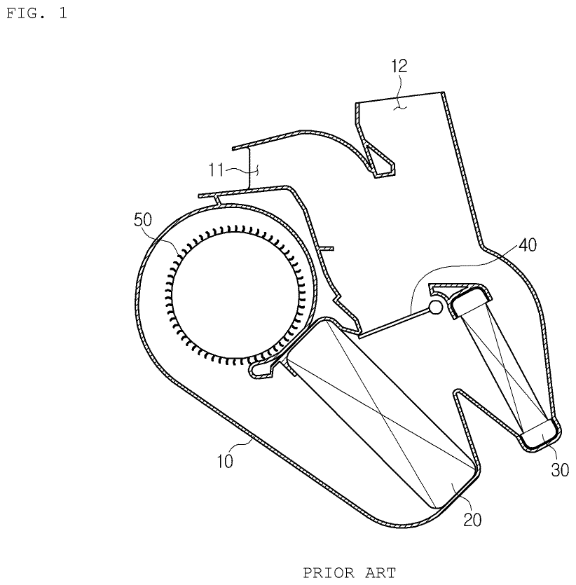

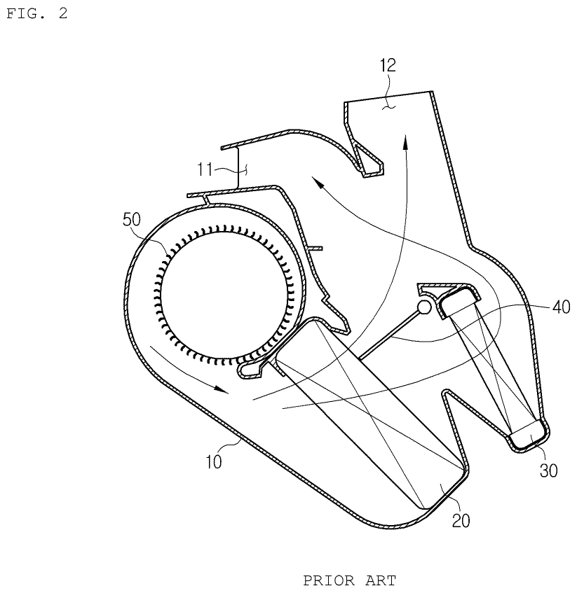

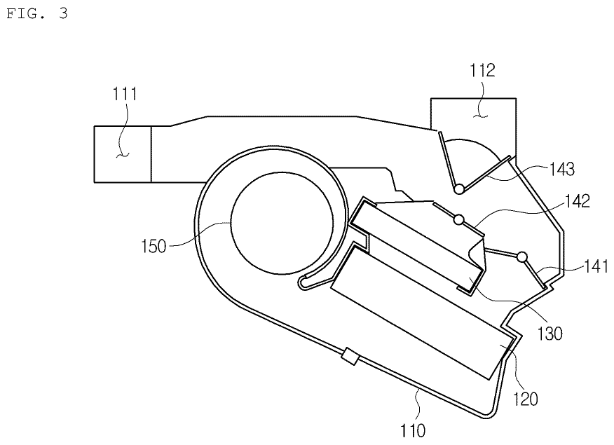

### DETAILED DESCRIPTION OF THE PREFERRED EMBODIMENT

Hereinafter, referring to the drawings, the technical configuration of an air conditioner for a vehicle will be described in detail.

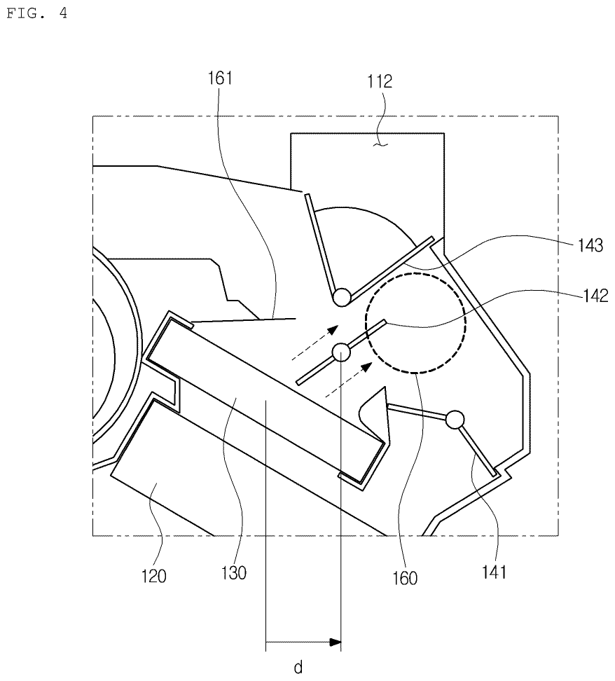

Referring to FIGS. 3 to 8, the air conditioner for a vehicle according to an embodiment of the present invention, which is a rear air conditioner installed on the rear side of the vehicle, includes an air blower 150, an air conditioning case 110, a cooling heat exchanger, a heating heat exchanger, a first temperature door 141, a second temperature door 142, and a mode door 143. In one example, the air conditioning case 110 is installed on the vehicle roof to perform rear seat air conditioning. Hereinafter, in the description, the left-right direction in FIG. 3 corresponds to the front-rear direction of the vehicle.

Inside the air conditioning case 110, an air passage is formed, and the air blower 150 is installed on the air inflow port side of the air conditioning case 110. The air blower 150 selectively draws in either inside air or outside air and blows the air into the air passage of the air conditioning case 110. The air conditioning case 110 includes a plurality of air discharge ports, including a face vent 112 for discharging air upward and a floor vent 111 for discharging air downward.

That is, the face vent 112 is an discharge port for blowing air toward a passenger's face, and the floor vent 111 is an discharge port for blowing air toward the passenger's feet. The face vent 112 is connected to a duct and extends to discharge air toward the passenger's face, primarily supplying cold air. The floor vent 111 is connected to a duct and extends downward to discharge air toward the passenger's feet, primarily supplying warm air.

The air passage of the air conditioning case 110 includes the cooling heat exchanger and the heating heat exchanger sequentially arranged in the airflow direction. The cooling heat exchanger is an evaporator 120, and the heating heat exchanger is a heater core 130. The refrigerant circulating through evaporator 120 exchanges heat with the air passing through the evaporator 120 to cool the air, and the coolant circulating through the heater core 130 exchanges heat with the air passing through the heater core 130 to heat the air. The cooling heat exchanger and the heating exchanger may also be implemented in other forms.

The air passage of the air conditioning case 110 includes a cold air passage and a warm air passage. The cold air passage is the passage through which air passes through the evaporator 120 and bypasses the heater core 130, and the warm air passage is the passage through which air passes through both the evaporator 120 and the heater core 130. The cold air passage and the warm air passage are separated by a partition inside the air conditioning case 110.

The first temperature door 141 controls the opening degree of the cold air passage, and the second temperature door 142 controls the opening degree of the warm air passage. The first temperature door 141 is a flat type having a flat that rotates around a rotary shaft. The first temperature door 141 may have a structure that flat parts extend on both sides of the rotary shaft or a structure that a flat part extends on one side of the rotary shaft.

The mode door 143 rotates between the face vent 112 and the floor vent 111, adjusting the opening degree between the face vent 112 and the floor vent 111. The mode door 143 is a dome-shaped door rotating around the rotary shaft. In this case, the mode door 143 is positioned downstream of the first and second temperature doors 141 and 142 in the airflow direction and is also positioned above the first temperature door 141 and the second temperature door 142 in the direction of gravity.

The evaporator 120 and the heater core 130 are arranged transversely. That is, the evaporator 120 and the heater core 130 are arranged horizontally so that both headers are position side by side in the transverse direction. In this case, the evaporator 120 and the heater core 130 are not perfectly horizontal but are installed in a form that is inclined close to the horizontal direction. Additionally, all the air discharge ports are formed at the upper side of the air conditioning case 110.

Accordingly, air blown by the air blower 150 flows upward from the bottom to the top within the air passage of the air conditioning case 110, and passes through the evaporator 120 or the heater core 130. The air, after passing through the evaporator 120 or the heater core 130, moves upward under the control of the first temperature door 141 and the second temperature door 142, and is discharged through the face vent 112 or the floor vent 111 under the control of the mode door 143.

Furthermore, the second temperature door 142 is a flat type having a flat that rotates around the rotary shaft. That is, the second temperature door 142 has a structure that the flats extend on both sides of the rotary shaft. In particular, when the second temperature door 142 opens the warm air passage, the second temperature door 142 is configured to guide the warm air passing through the heater core 130 into the cold air passage.

The second temperature door 142 is positioned downstream of the heater core 130 in the airflow direction. Additionally, the second temperature door 142 is positioned above the first temperature door 141 in the direction of gravity. Moreover, the second temperature door 142 is positioned inside the heater core 130 in the front-rear direction of the vehicle. Due to the configuration, the overall size of the air conditioner is minimized in the vertical height direction and the front-rear direction of the vehicle and enabling control of cold air and warm air.

Furthermore, by adjusting the amount of cooling and heating air through the first and second temperature doors 141 and 142, the air conditioner for a vehicle according to the present invention enables more precise and fine temperature control compared to the structure having just one temperature door.

Specifically, the opening direction of the second temperature door 142 faces the cold air passage downstream of the first temperature door 141 in the airflow direction. That is, when the second temperature door 142 is fully open, the flat is aligned parallel to the cold air passage downstream of the first temperature door 141. In other words, when the second temperature door 142 opens the warm air passage, the second temperature door 142 faces the upper portion of the first temperature door 141 in the vertical (gravity) direction.

As described above, the first temperature door 141 and the second temperature door 142 have flats rotating around the rotary shaft. Additionally, when both the first and second temperature doors 141 and 142 are opened simultaneously, the extension lines of the flat ends of the first temperature door 141 and the second temperature door 142 meet in an upstream space of the mode door 143 in the airflow direction.

That is, when the first temperature door 141 is opened, the cold air moves vertically toward the air discharge port (face vent) located at the upper portion of the first temperature door 141. Moreover, when the second temperature door 142 is opened, the warm air moves to meet the upward-moving cold air, forming a mixing zone at the lower portion of the air discharge port (face vent).

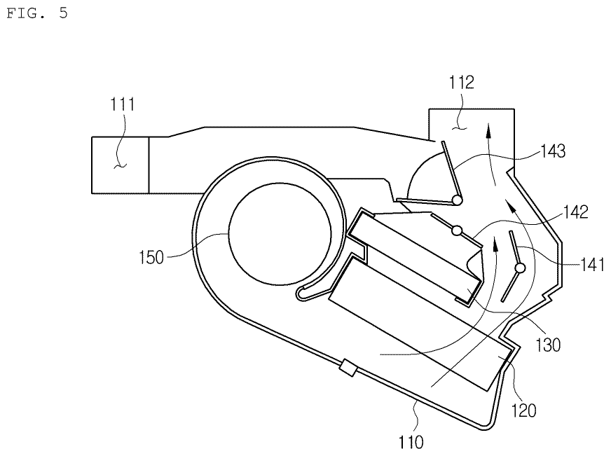

FIG. 4 illustrates the maximum opening state of the second temperature door 142. As illustrated in FIG. 4, when the second temperature door 142 is opened, the air moves toward the cold air passage 160 downstream of the first temperature door 141, as indicated by the dashed arrow. The downstream cold air passage 160 of the first temperature door 141 becomes a mixing zone where the cold air bypassing the heater core 130 and the warm air passing through the heater core 130 are mixed.

As described above, by controlling the opening direction of the warm air passage of the second temperature door 142, which adjusts the amount of warm air passing through the heater core 130, to face the cold air passage, the warm air passing through the warm air passage and the cold air passing through the cold air passage are mixed smoothly, enhancing the mixing performance of the air conditioner.

Additionally, the second temperature door 142 is offset toward the cold air passage relative to the center in the longitudinal direction of the heater core 130. As illustrated in FIG. 4, the rotary shaft of the second temperature door 142 is positioned a certain distance (d) toward the cold air passage from the center in the longitudinal direction of the heater core 130. That is, the rotary shaft of the second temperature door 142 is positioned closer to the rotary shaft of the first temperature door 141 in the longitudinal direction of the heater core 130.

Through the above arrangement, the position where the warm air passing through the heater core 130 passes through the second temperature door 142 is finally formed at a portion adjacent to the cold air passage so that the warm air passing through the warm air passage and the cold air passing through the cold air passage are mixed together smoothly, thereby improving the mixing performance of the conditioned air. Such an effect is achieved through the configuration where the second temperature door 142 is offset toward the cold air passage from the center in the longitudinal direction of the heater core 130, and the configuration where the second temperature door 142 is arranged inside the heater core 130 in the front-rear direction of the vehicle. Ultimately, the size of the air conditioner can be minimized in the front-rear direction of the vehicle and the mixing performance of cold air and the warm air can be improved.

Furthermore, an upper closing surface 161 of the second temperature door 142 is located within the rotation radius of the mode door 143. The air passing through the heater core 130 flows toward a mixing zone, where cold air and warm air are mixed, through the upper closing surface 161 of the air conditioning case 110. The mixing zone is formed within the rotation radius of the mode door 143. The cold air and the warm air mixed in the mixing zone are selectively discharged through the face vent 112 or the floor vent 111 by the rotational operation of the mode door 143.

As a result, since the upper closing surface 161 is positioned within the rotation radius of the mode door 143, the air passing through the heater core 130 is guided into the mixing zone (the cold air passage 160 downstream of the first temperature door) within the rotation radius of the mode door 143, and flows toward the floor vent 111, which is the warm air discharge port, thus increasing the airflow to the warm air discharge port and improving the mixing of cold air and warm air.

That is, the rotary shaft of the mode door 143 is positioned in the vertical direction (in the gravity direction) above the rotary shaft of the second temperature door 142. In an air conditioning mode where both the first temperature door 141 and the second temperature door 142 are open, the upper closing surface 161 of the second temperature door 142 is positioned within the dome of the mode door 143 in the front-rear direction of the vehicle.

Meanwhile, the heater core 130 is arranged adjacent to the air discharge port through which warm air is discharged. In this case, the air discharge port through which warm air is discharged is the floor vent 111. That is, the heater core 130 is positioned such that the warm air flows directly to the floor vent 111 during heating mode. More specifically, the warm air passage, through which the air passing through the heater core 130 flows, is arranged adjacent to the floor vent 111, and the cold air passage, through which air passing through the evaporator 120 and bypassing the heater core 130 flows, is arranged adjacent to the face vent 112.

As described above, by optimizing the position of the heater core 130 such that warm air can flow directly to the floor vent 111, which is the warm air discharge port, during heating mode, air resistance is reduced, contributing to an increase in airflow.

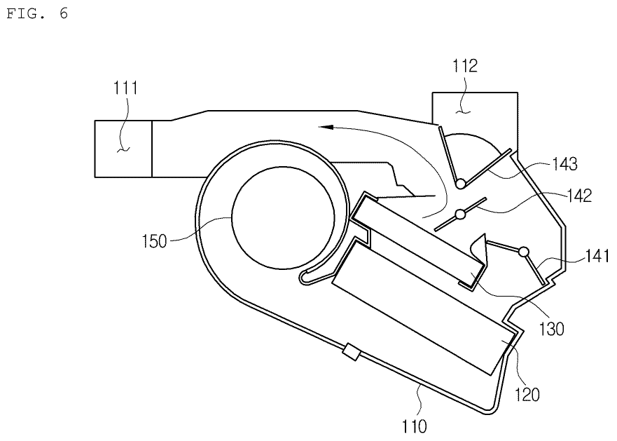

As illustrated in FIG. 5, in a vent mode, the first temperature door 141 opens the cold air passage, and the second temperature door 142 closes the warm air passage. The mode door 143 closes the floor vent 111 and opens the face vent 112. The air blown from the air blower 150 moves upward from the bottom, and is cooled while passing through the evaporator 120. The cold air then passes through the first temperature door 141 and continues moving upward, passes through the mode door 143, and then, is discharged upward toward the face vent 112.

In this case, since the cold air passage is arranged adjacent to the face vent 112, the cold air that has passed through the evaporator 120 reaches the face vent 112 with the minimum distance, thereby reducing air resistance and increasing airflow.

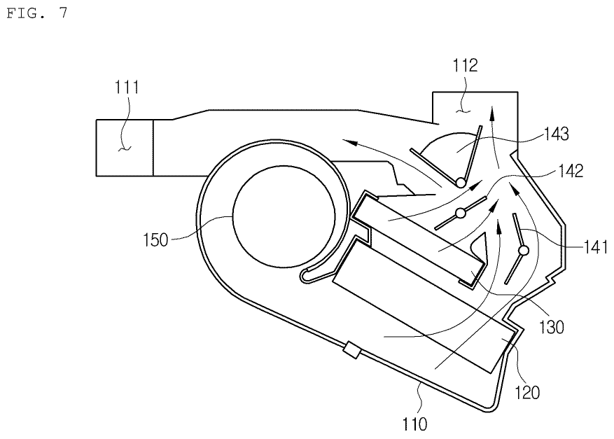

As illustrated in FIG. 6, in a floor mode, the first temperature door 141 closes the cold air passage, and the second temperature door 142 opens the warm air passage. The mode door 143 opens the floor vent 111 and closes the face vent 112. The air blown from the air blower 150 moves upward from the bottom, passes through the evaporator 120, and then, passes through the heater core 130. The warm air that has passed through the heater core 130 continues moving upward after passing through the second temperature door 142, passes through the mode door 143, and flows upward toward the floor vent 111. Afterward, the warm air moves forward in the vehicle, moves downward along the duct, and then, is discharged toward the interior of the vehicle.

In this case, since the warm air passage is arranged adjacent to the floor vent 111, the warm air that has passed through the heater core 130 reaches the floor vent 111 with the minimum distance, thereby reducing air resistance and increasing airflow.

As illustrated in FIG. 7, in a bi-level mode, the first temperature door 141 opens the cold air passage, and the second temperature door 142 opens the warm air passage. The mode door 143 is positioned between the floor vent 111 and the face vent 112 and opens both the floor vent 111 and the face vent 112.

Some of the air blown from the air blower 150 moves upward from the bottom, is cooled while passing through the evaporator 120, and some of the air moves upward from the bottom and is heated while passing through the heater core 130. The cold air and the warm air are mixed in the mixing zone which is the cold air passage downstream of the first temperature door 141, pass through the mode door 143, and then, are discharged into the interior of the vehicle through both the face vent 112 and the floor vent 111.

In this case, when the second temperature door 142 is opened toward the cold air passage, warm air is directed toward the cold air passage, thereby improving the mixing of cold air and warm air. Additionally, since the cold air passage is arranged adjacent to the face vent 112 and the warm air passage is arranged adjacent to the floor vent 111, the cold air and the warm air respectively reach the face vent 112 and the floor vent 111 with the minimum distance, thereby reducing air resistance and increasing airflow.

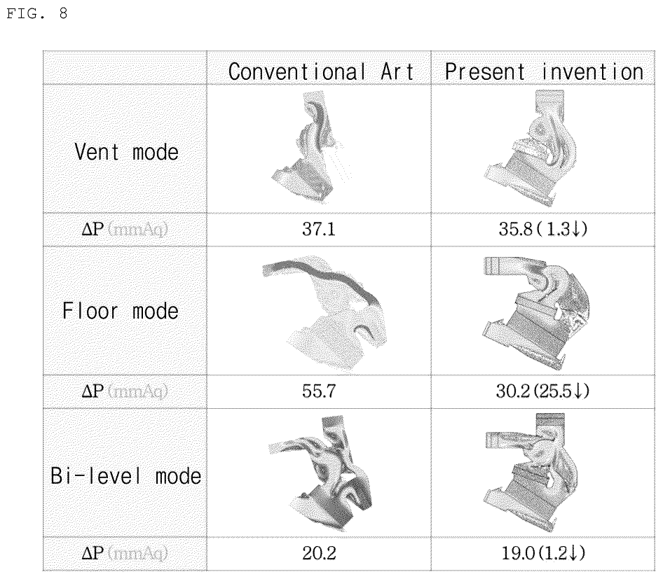

As illustrated in FIG. 8, through experiments, it was confirmed that the air conditioner for the vehicle according to an embodiment of the present invention exhibited reduction of air resistance in the vent mode, the floor mode, and the bi-level mode compared to conventional arts. As described above, by optimizing the position of the heater core 130 and optimizing the opening direction and position of the second temperature door, the air conditioner for the vehicle according to an embodiment of the present invention can reduce air resistance and increase airflow, thus reducing the power consumption of the blower motor of the air blower 150 and improving air conditioning efficiency. In addition, the air conditioner for the vehicle according to an embodiment of the present invention can enhance the mixing of cold air and warm air, thereby improving indoor comfort.

The air conditioner for a vehicle according to the present invention has been described with reference to the embodiments shown in the drawings, but the embodiments are merely examples. It should be apparent that modifications and variations can be made by persons skilled without deviating from the spirit or scope of the present invention. Therefore, the true scope of technical protection should be defined by the spirit of the appended claims.

What is claimed is:

1. An air conditioner for a vehicle, which includes an air conditioning case having an air passage formed therein, and a cooling heat exchanger and a heating heat exchanger sequentially provided in the air passage in an airflow direction,
wherein the air passage includes a cold air passage through which air passing through the cooling heat exchanger bypasses the heating heat exchanger, and a warm air passage through which air passing through the cooling heat exchanger passes through the heating heat exchanger,
wherein a first temperature door for controlling the opening degree of the cold air passage, and a second temperature door for controlling the opening degree of the warm air passage are provided, and
wherein when the second temperature door opens the warm air passage, the second temperature door guides the warm air passing through the heating heat exchanger to the cold air passage.

2. The air conditioner according to claim 1, wherein a plurality of air discharge ports are formed in the air conditioning case, and the plurality of the air discharge ports are formed at an upper portion of the air conditioning case.

3. The air conditioner according to claim 2, wherein the air conditioning case is provided at a rear seat of the vehicle and performs air conditioning for the rear seat of the vehicle.

4. The air conditioner according to claim 2, wherein the second temperature door is arranged downstream of the heating heat exchanger in an airflow direction.

5. The air conditioner according to claim 4, wherein the second temperature door is a flat type having a flat that rotates around a rotary shaft, and
wherein the opening direction of the second temperature door is toward the cold air passage downstream of the first temperature door in the airflow direction.

6. The air conditioner according to claim 5, wherein the second temperature door has a structure that flats extend on both sides around the rotary shaft, and
wherein when the second temperature door is fully opened, the flats are formed parallel toward the cold air passage downstream of the first temperature door in the airflow direction.

7. The air conditioner according to claim 4, wherein the second temperature door is offset toward the cold air passage relative to the center in the longitudinal direction of the heating heat exchanger.

8. The air conditioner according to claim 4, wherein the air discharge ports include a face vent for discharging air toward a passenger's face and a floor vent for discharging air toward the passenger's feet,
wherein a mode door for adjusting the opening degree between the face vent and the floor vent is provided, and
wherein an upper closing surface of the second temperature door is located within the rotation radius of the mode door.

9. The air conditioner according to claim 8, wherein the cooling heat exchanger and the heating heat exchanger are arranged to be laid horizontally, and
wherein the heating heat exchanger is arranged adjacent to the air discharge port through which warm air is discharged.

10. The air conditioner according to claim 9, wherein the heating heat exchanger is arranged so that in a heating mode, warm air flows directly into the floor vent.

11. The air conditioner according to claim 10, wherein the warm air passage through which air passing through the heating heat exchanger flows is arranged adjacent to the floor vent, and
wherein the cold air passage through which air passing through the cooling heat exchanger and bypassing the heating heat exchanger flows is arranged adjacent to the face vent.

12. The air conditioner according to claim 5, wherein when the second temperature door opens the warm air passage, the second temperature door faces an upper portion of the first temperature door in the vertical direction.

13. The air conditioner according to claim 8, wherein the first temperature door and the second temperature door all have flats that rotate around the rotary shaft, and
wherein when both the first temperature door and the second temperature door are opened simultaneously, an extension line of a flat end of the first temperature door and an extension line of a flat end of the second temperature door meet in an upstream space of the mode door in the airflow direction.

14. The air conditioner according to claim 5, wherein when the first temperature door is opened, cold air moves vertically toward the air discharge port located above the first temperature door, and
wherein when the second temperature door is opened, warm air moves to meet the cold air moving upward, forming a mixing zone below the air discharge port.

15. The air conditioner according to claim 7, wherein the rotary shaft of the second temperature door is arranged closer to the rotary shaft of the first temperature door than to the center in the longitudinal direction of the heating heat exchanger.

16. The air conditioner according to claim 11, wherein the mode door is formed in a dome-shape which rotates around the rotary shaft, and
wherein when both the first temperature door and the second temperature door are opened, the upper closing surface of the second temperature door is located within the dome of the mode door in a front-rear direction of the vehicle.

17. The air conditioner according to claim 11, wherein the mode door is formed in a dome-shape which rotates around the rotary shaft, and
wherein the rotary shaft of the mode door is located above the rotary shaft of the second temperature door in the vertical direction.
